(19) United States
(12) Patent Application Publication
(10) Pub. No.: US 2026/0238603 A1
(43) Pub. Date: Aug. 13, 2026

(54) LOCKLESS TECHNIQUE FOR DATA PACKET QUEUE DISPOSITION

(71) Applicant: QUALCOMM Incorporated, San Diego, CA (US)

(72) Inventors: John MARK, San Diego, CA (US); Thyagarajan VENKATANARAYANAN, San Diego, CA (US); Amol MAHESH, San Diego, CA (US); Michael CASTELLOE, San Diego, CA (US)

(21) Appl. No.: 19/053,264

(22) Filed: Feb. 13, 2025

(51) Int. Cl. H04L 47/50

(52) U.S. Cl. CPC H04L 47/50

(57) ABSTRACT

Aspects of the disclosure are directed to lockless technique for data packet queue disposition. In accordance with one aspect, the disclosure includes placing a first plurality of data packets from a client of a plurality of clients into an assigned queue of a plurality of queues, wherein the assigned queue is associated with the client; transferring one or more contents of a notify queue list to a temporary notify list; retrieving a second plurality of data packets from the plurality of queues based on the temporary notify list; and processing the second plurality of data packets according to a plurality of client applications to generate a plurality of transformed data packets.

### TECHNICAL FIELD

This disclosure relates generally to the field of information processing systems, and, in particular, to a lockless technique for data packet queue disposition.

### BACKGROUND

An information processing system requires transport of data packets from a first entity to a second entity. A plurality of users (e.g., clients) may produce a plurality of data packets which are placed in a plurality of queues (e.g., a plurality of interface buffers). Another entity (e.g., a server) may be a consumer of the plurality of data packets and requires access to the plurality of queues for disposition of the plurality of data packets. One technique for queue access uses sequential polling to interrogate each queue of the plurality of queues. However, sequential polling may be an inefficient mechanism for packet disposition and an alternative packet disposition mechanism may improve efficiency, particularly for contemporary artificial intelligence (AI) applications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a lockless technique for data packet queue disposition. Accordingly, the present disclosure discloses a method including: placing a first plurality of data packets from a client of a plurality of clients into an assigned queue of a plurality of queues, wherein the assigned queue is associated with the client; transferring one or more contents of a notify queue list to a temporary notify list; retrieving a second plurality of data packets from the plurality of queues based on the temporary notify list; and processing the second plurality of data packets according to a plurality of client applications to generate a plurality of transformed data packets.

Another aspect of the disclosure provides an apparatus including: a non-transitory memory configured to store a first plurality of data packets and a second plurality of data packets; a processing engine coupled to the non-transitory memory, the processing engine configured to transfer one or more contents of a notify queue list to a temporary notify list and further configured to process the second plurality of data packets according to a plurality of client applications to generate a plurality of transformed data packets; and a databus coupled to the non-transitory memory and the processing engine, the databus configured to interconnect the processing engine and the non-transitory memory to transport the first plurality of data packets, the second plurality of data packets and the plurality of transformed data packets.

Another aspect of the disclosure provides a non-transitory computer-readable medium storing computer executable code, operable on a device including at least one processor and at least one memory coupled to the at least one processor, wherein the at least one processor is configured to implement a lockless technique for data packet queue disposition, the computer executable code including: instructions for causing a computer to place a first plurality of data packets from a client of a plurality of clients into an assigned queue of a plurality of queues, wherein the assigned queue is associated with the client; instructions for causing the computer to transfer one or more contents of a notify queue list to a temporary notify list; instructions for causing the computer to retrieve a second plurality of data packets from the plurality of queues based on the temporary notify list; and instructions for causing the computer to process the second plurality of data packets according to a plurality of client applications to generate a plurality of transformed data packets.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example queue access technique using sequential polling.

FIG. 3 illustrates an example queue access technique using a notify queue list.

FIG. 4 illustrates an example flow diagram to implement lockless technique for data packet queue disposition.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

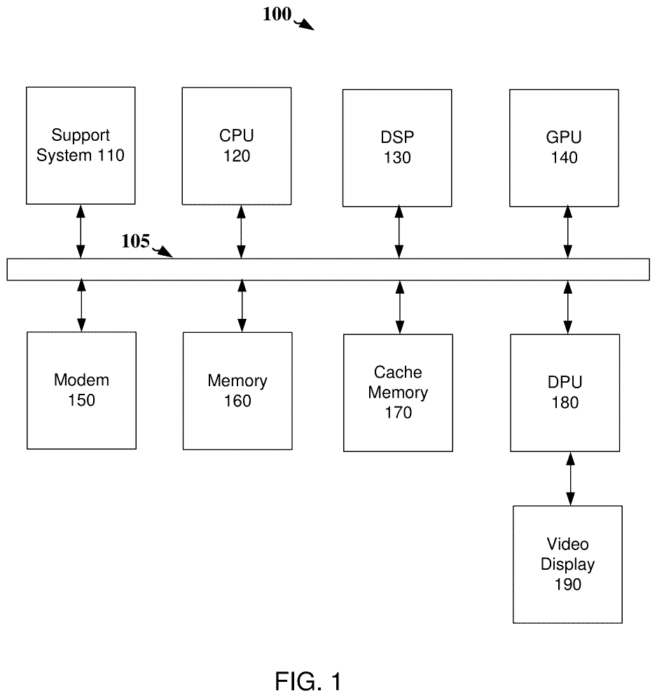

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, an information processing system may include augmented reality (AR) devices or virtual reality (VR) devices. In one example, the information processing system may be used for artificial intelligence (AI) applications.

In one example, an example AI use case for mobile or automotive applications may utilize one or more queues where a plurality of data packets produced by a first processing engine (e.g. a CPU) are placed (i.e., written) into a queue and retrieved (i.e., read) and processed by a second processing engine (e.g., a DSP). For example, the retrieval and processing of the plurality of data packets may be part of a disposition of the plurality of data packets. For example, the plurality of data packets may be used to trigger inferences in an AI application.

In one example, the information processing system may have a client-server architecture. For example, the client-server architecture may include a plurality of clients (e.g. plurality of users), which execute different applications or tasks. In one example, the plurality of clients may require external services (e.g., external processing resources or databases) which are not locally available to the plurality of clients. Such external services may be provided by a server; that is, a processing engine which provides external services to the plurality of clients. For example, the client-server architecture includes at least one server which services the plurality of clients.

In one example, information from the plurality of clients may be in the form of a plurality of data packets which are sent to the server. In one example, since the server may need to provide services to the plurality of clients in a sequential manner, the plurality of data packets may need to be placed into a plurality of queues which provide temporary storage of the plurality of data packets prior to service access and processing.

In one example, a queue is a data structure which stores a plurality of data packets. For example, the queue may be a first in first out (FIFO) data structure where the first data packet of the plurality of packets placed (i.e., written) into the queue is the first data packet retrieved (i.e., read) from the queue. In one example, the plurality of data packets is produced by a plurality of clients in the first processing engine. In one example, the plurality of data packets is processed by a server in the second processing engine.

In one example, a data packet is an aggregation of data bits used as an elemental unit of data transport. That is, the data packet is formatted into a particular packet format (e.g., with a header field and a payload field) and then transported over a data interface. In one example, each data packet may be placed into a queue for temporary storage prior to servicing by the server. For example, a data packet in the queue may be denoted as a pending data packet (i.e., awaiting servicing by the server). In one example, each client of the plurality of clients may be assigned a queue in the plurality of queues. That is, the server may need to access each queue in the plurality of queues in a particular order for each client of the plurality of clients.

In one example, queue access by the server may be through sequential polling. In one example, sequential polling interrogates (i.e., examines) each queue of the plurality of queues in a particular order. For example, the particular order may be an interrogation cycle from a first queue to a second queue and so on until a last queue before repeating the interrogation cycle. In one example, the sequential polling by the server iterates through the plurality of queues in a cycle to determine if there are one or more pending data packets in each queue of the plurality of queues. In one example, when the sequential polling finds a queue with one or more pending data packets, it retrieves them from the queue and processes the data packets according to an application requirement.

In one example, sequential polling is not temporally efficient since many queues of the plurality of queues are empty (i.e., have no pending data packets); hence many queue interrogations are unnecessary and result in wasted processing time. Consequently, a more efficient and lockless queue access technique is desired where the server may quickly identify which queues of the plurality of queues have pending data packets (i.e., are not empty) so they may be processed (i.e., serviced) more rapidly. For example, lockless refers to a queue property where there is no mutual exclusion among the plurality of clients and the server for queue access. That is, the queue access technique should not prohibit any client from placing new data packets in its queue while the server accesses any queue in the plurality of queues.

In one example, an alternative lockless queue access technique allows for any client to place new data packets in a lockless manner to its queue and also allows the server to identify when new data packets are available for retrieval and subsequent processing in a lockless manner.

In one example, the alternative lockless queue access technique employs three distinctive features:
1. Usage of an N bit atomic variable (e.g., notify_queue_list), to identify which queues of the plurality of queues have pending data packets by producing a list of queues.
2. Usage of an atomic read operation to retrieve a batch of pending data packets from a queue and an atomic exclusive OR (XOR) logical operation to clear the batch of pending data packets from the queue.
3. Usage of a bit count instruction (e.g., a count leading zeros instruction) to iterate through the list of queues which have pending data packets.
   In one example, an atomic variable is a variable which may be read or written without interruption or interference. In one example, an atomic operation is an operation which allows concurrent operation with other operations from any client or the server.

In one example, the N bit atomic variable may identify which queues in the plurality of queues have pending data packets by using one bit (i.e., binary digit) to indicate whether or not a queue in the plurality of queues has pending data packets present in its queue. For example, N=64 for a plurality of queues with 64 clients. In one example, each bit of the N bit atomic variable is enabled (i.e., set to one) when its associated queue has at least one pending data packet for the server to consume. In one example, each bit is disabled (i.e., set to zero) when its associated queue is empty (i.e., has no pending data packets). In one example, the N bit atomic variable may be denoted as a notify_queue_list. In one example, usage of the atomic read operation, atomic XOR logical operation and notify_queue_list results in lockless operation. That is, the lockless operation allows the server to access a queue from the plurality of queues for processing while one or more clients may be updating the notify_queue_list.

In one example, the alternative lockless queue access technique has the following pseudo-code for its client operation:
Write packet to queue
Atomic64 set bit queue index in notify_queue_list

In one example, the alternative lockless queue access technique has the following pseudo-code for its server operation:
In polling thread
While (1)
   tmp_notify_list=Atomic64 read notify_queue_list
   //clear the queue IDs which have outstanding packets in
notify_queue_list
   notify_queue_list=Atomic64 XOR (notify_queue_list, tmp_notify_list
   For each bit index set in tmp_notify_list//use clzl ot iterate
      Queue_ID=bit index
      Queue=getQueue(Queue_Id)
      Handoff queue to be processed by thread from thread pool.

In one example, a processing thread (i.e., process) will consume all outstanding data packets in the queue. For example, the processing thread may be woken up to examine a queue which is now empty. For example, the client may place data packets to a queue with its corresponding bit in the notify_queue_list set to 1 after it is read into the tmp_notify_list, but before it is cleared by the atomic XOR logical operation, since all pending data packets will be handled by the processing thread. For example, the client may set a new bit in the notify_queue_list after it is read into the tmp_notify_list, where those packets will be handled on the next iteration of the polling thread.

In one example, the alternative lockless queue access technique may scale to more than 64 queues by augmenting with additional 64-bit atomic variables to index additional queues. For example, the additional 64-bit atomic variables may be used to scale to a higher quantity of queues. In one example, preemptive scheduling may be supported to prevent processing overload if data packets are continually added to the queue. For example, preemption scheduling employs deterministic planning for queue access as a resource allocation technique. In one example, the processor supports a bit count instruction (e.g., a count leading zeros instruction) to iterate through the list of queues which have pending data packets. For example, the count leading zeros instruction may be used to determine a first enabled (i.e., set to one) bit in a 64-bit atomic variable which corresponds to a data queue with at least one ready data packet.

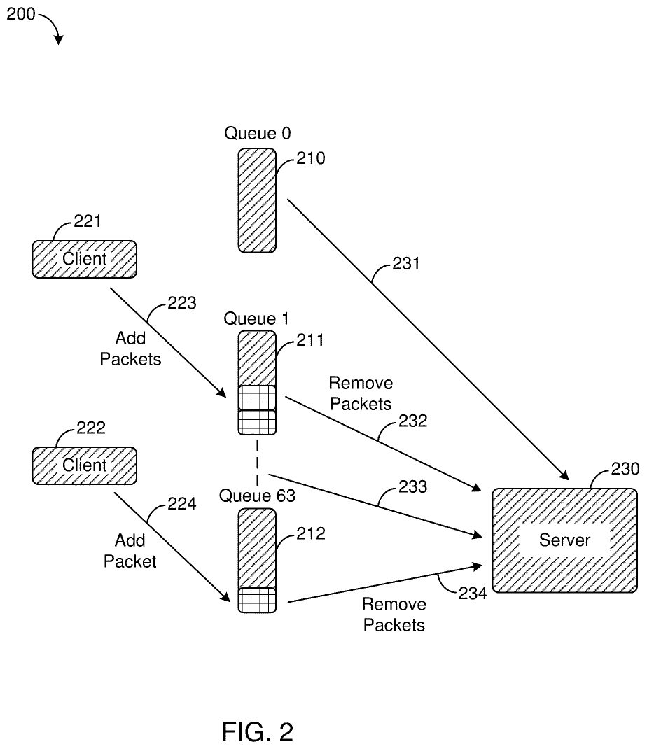

FIG. 2 illustrates an example queue access technique 200 using sequential polling. In one example, the queue access technique 200 using sequential polling includes a plurality of queues including a first queue (e.g., Queue 0) 210, a second queue (e.g. Queue 1) 211 and so on until an Nth queue (e.g., Queue 63) 212. In one example, a plurality of clients, including a first client 221 and a second client 222 access the plurality of queues. For example, the first client 221 may place a first plurality of data packets 223 to the second queue 211. For example, the second client 222 may place a second plurality of data packets 224 to the Nth queue 212.

In one example, a server 230 retrieves (i.e., removes) a first plurality of data packets 231 from the first queue (e.g., Queue 0) 210, a second plurality of data packets 232 from the second queue (e.g. Queue 1) 211, a third plurality of data packets 233 from another queue (not shown) and a fourth plurality of data packets 234 from the Nth queue (e.g., Queue 63) 212. In one example, the server 230 operates with sequential polling with a polling loop. For example, the server 230 checks each queue of the plurality of queues to see if it has pending data packets. For example, if one queue has pending data packets, then the pending data packets are sent to the server 230 for disposition (e.g., processing).

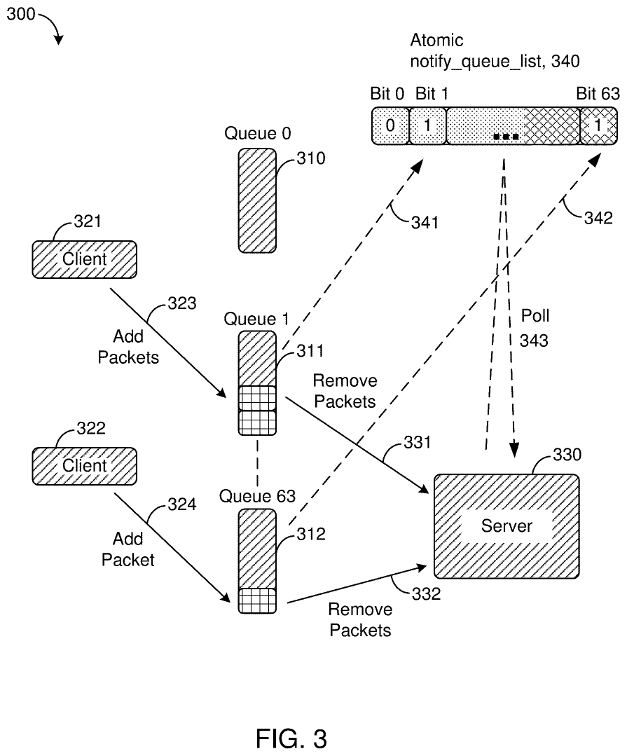

FIG. 3 illustrates an example queue access technique 300 using a notify queue list. In one example, the queue access technique 300 using a notify queue list includes a plurality of queues including a first queue (e.g., Queue 0) 310, a second queue (e.g. Queue 1) 311 and so on until an Nth queue (e.g., Queue 63) 312. In one example, a plurality of clients, including a first client 321 and a second client 322 access the plurality of queues. For example, the first client 321 may place a first plurality of data packets 323 into the second queue 311. For example, the second client 322 may place a second plurality of data packets 324 into the Nth queue 312.

In one example, a server 330 retrieves (i.e., removes) the first plurality of data packets 331 from the second queue (e.g. Queue 1) 311 and retrieves the second plurality of data packets 332 from the Nth queue (e.g., Queue 63) 312.

In one example, the server 330 operates with a notify queue list 340. In one example, the notify queue list 340 includes N constituents (i.e., N bits) where each constituent (i.e., each bit) corresponds to each queue of the plurality of queues. For example, the second queue (e.g., Queue 1) corresponds to a second bit (e.g. Bit 1) 341 of the notify queue list 340. For example, the Nth queue (e.g., Queue 63) corresponds to an Nth bit (e.g. Bit 63) 342 of the notify queue list 340.

In one example, the server 330 interrogates (i.e., examines) the notify queue list 340 to determine a presence of enabled bits (i.e., bits set to one) which indicates which queues of the plurality of queues have pending data packets. In one example, the atomic notify queue list is stored in a memory accessible by both the plurality of queues and the server 330.

In one example, the plurality of queues will have a subset of queues which have pending data packets. For example, when a client places a data packet to its corresponding queue, the corresponding queue enables its bit index in the notify queue list 340. For example, the server 330 performs an atomic read of the notify queue list 340 into a temporary notify list to determine which queues of the plurality of queues have pending data packets. In one example, the temporary notify list is used to hold a copy of the notify queue list for determination of which queues of the plurality of queues have pending data packets. For example, the server 330 supports a bit count instruction (e.g., a count leading zeros instruction) to iterate through the list of queues which have pending data packets.

In one example, the server 330 performs an atomic XOR logical operation of the notify queue list 340 with the temporary notify list to clear known pending data packet queues from the notify queue list 340. In one example, the pending data packet queues are queues of the plurality of queues which have pending data packets.

For example, the server 330 processes all pending data packets for each queue in the temporary notify list using a processing thread from a thread pool.

In one example, the queue access technique using sequential polling continually iterates through all queues in the plurality of queues, so it operates on the plurality of queues (quantity n) with order n (i.e., O(n)). In one example, the queue access technique using a notify queue list only iterates through queues which have pending data packets, so it operates on a subset of queues (quantity k) with order k (i.e., O(k)), where k<n, and usually k<<n. Moreover, the queue access technique using a notify queue list clears the list of queues with pending data packets with order 1 (i.e., O(1)) in a lockless manner. In one example, order refers to a an upper mathematical bound on a sequence f(n) such that f(n)=O(g(n)) if |f(n)|<M|g(n)| for all n>n₀ and M=a bounding integer and n₀=a transition integer.

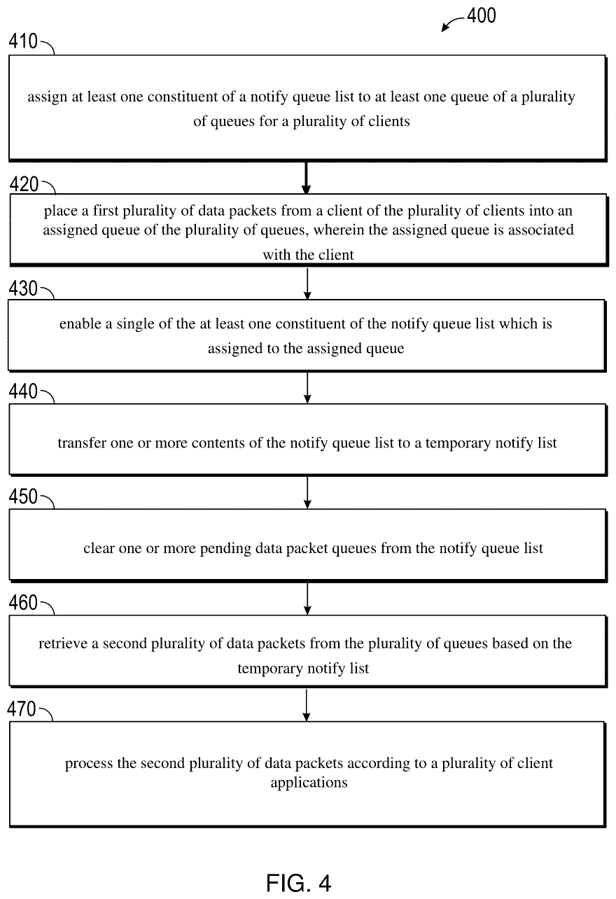

FIG. 4 illustrates an example flow diagram 400 to implement lockless technique for data packet queue disposition. In block 410, assign at least one constituent of a notify queue list to at least one queue of a plurality of queues for a plurality of clients. In one example, at least one constituent of a notify queue list is assigned to at least one queue of a plurality of queues for a plurality of clients.

In one example, each queue of the plurality of queues is part of an information processing system. In one example, the constituents of the notify queue list are individual bits (i.e., binary digits) of the notify queue list. In one example, the notify queue list has a dimension of N bits. In one example, the dimension is 64 bits. In one example, each queue is associated with one client of the plurality of clients. In one example, the assigning is performed by a first processing engine associated with the server.

In block 420, place a first plurality of data packets from a client of the plurality of clients into an assigned queue of the plurality of queues, wherein the assigned queue is associated with the client. In one example, a first plurality of data packets from a client of the plurality of clients is placed into an assigned queue of the plurality of queues, wherein the assigned queue is associated with the client.

In one example, the first plurality of data packets is generated by an application in the client. In one example, the first plurality of data packets require disposition by a server. In one example, the placement is performed by a second processing engine associated with the client.

In block 430, enable a single of the at least one constituent of the notify queue list which is assigned to the assigned queue. In one example, a single of the at least one constituent of the notify queue list which is assigned to the assigned queue is enabled. In one example, the single constituent is a single bit of the notify queue list. In one example, enabling is performed by setting the single bit to a logical value of one. In one example, the enabling is performed by the second processing engine associated with the client.

In block 440, transfer one or more contents of the notify queue list to a temporary notify list. In one example, one or more contents of the notify queue list is transferred to a temporary notify list. In one example, the transferring uses an atomic read operation on the notify queue list. In one example, the transferring is performed by the first processing engine associated with the server. In one example, contents of the notify queue list are the data stored in the notify queue list. In one example, contents of the notify queue may include an aggregation of all the constituents of the notify queue list.

In block 450, clear one or more pending data packet queues from the notify queue list. In one example, one or more pending data packet queues is cleared from the notify queue list. In one example, the clearing is executed by computing an atomic XOR logical operation with the notify queue list and the temporary notify list. In one example, pending data packet queues are queues which are populated with data packets needing disposition. In one example, the clearing is performed by the first processing engine associated with the server.

In block 460, retrieve a second plurality of data packets from the plurality of queues based on the temporary notify list. In one example, a second plurality of data packets is retrieved from the plurality of queues based on the temporary notify list. In one example, the retrieval uses a count leading zeros instruction to iterate through the list of queues which have pending data packets. In one example, the retrieving includes retrieving the first plurality of data packets. In one example, the retrieving is performed by the first processing engine associated with the server.

In block 470, process the second plurality of data packets according to a plurality of client applications. In one example, the second plurality of data packets is processed according to a plurality of client applications. In one example, a client application is an application performed by a client. In one example, an application is a software program, a database, etc. In one example, the processing is performed to generate application results which are returned to the plurality of clients. In one example, the processing of the second plurality of data packets generates a plurality of transformed data packets, wherein the plurality of transformed data packets is not equal to the second plurality of data packets.

In one example, the second plurality of data packets is an input to a functional operation and the plurality of transformed data packets is an output of the functional operation. In one example, the functional relationship changes a first dimension of the second plurality of data packets to a second dimension of the plurality of transformed data packets. In one example, the plurality of transformed data packets is conveyed (e.g., via a modem) to an external entity. In one example, the external entity may be a remote client, a remote database, a cloud server, a remote computer, a remote processing engine, etc. In one example, the processing is performed by the first processing engine associated with the server.

In one example, a method including: placing a first plurality of data packets from a client of a plurality of clients into an assigned queue of a plurality of queues, wherein the assigned queue is associated with the client; transferring one or more contents of a notify queue list to a temporary notify list; retrieving a second plurality of data packets from the plurality of queues based on the temporary notify list; and processing the second plurality of data packets according to a plurality of client applications to generate a plurality of transformed data packets.

In one example, the transferring uses an atomic read operation on the notify queue list. In one example, the one or more contents of the notify queue list are data stored in the temporary notify list. In one example, the one or more contents include an aggregation of all constituents of the notify queue list. In one example, one of the all constituents is a single bit of the notify queue list. In one example, the retrieving uses a count leading zeros instruction to iterate through a list of queues having one or more pending data packets. In one example, the processing is performed to generate one or more application results which are returned to the plurality of clients.

In one example, the method further includes enabling a single of at least one constituent of the notify queue list. In one example, the enabling is performed by setting a single bit to a logical value of one. In one example, the method further includes assigning the at least one constituent of the notify queue list to at least one queue of the plurality of queues. In one example, the method further includes clearing one or more pending data packet queues from the notify queue list. In one example, the clearing is executed by computing an atomic XOR logical operation using the notify queue list and the temporary notify list.

In one example, an apparatus including: a non-transitory memory configured to store a first plurality of data packets and a second plurality of data packets; a processing engine coupled to the non-transitory memory, the processing engine configured to transfer one or more contents of a notify queue list to a temporary notify list and further configured to process the second plurality of data packets according to a plurality of client applications to generate a plurality of transformed data packets; and a databus coupled to the non-transitory memory and the processing engine, the databus configured to interconnect the processing engine and the non-transitory memory to transport the first plurality of data packets, the second plurality of data packets and the plurality of transformed data packets.

In one example, the apparatus further includes a display processing unit (DPU) coupled to the non-transitory memory, the DPU configured to display the plurality of transformed data packets. In one example, the apparatus further includes a modem coupled to the non-transitory memory, the modem configured to convey the plurality of transformed data packets to an external entity. In one example, the apparatus further includes a digital signal processor (DSP) coupled to the non-transitory memory, the DSP configured to transform a signal embedded within the second plurality of data packets to generate a transformed signal not equal to the signal. In one example, the apparatus further includes a video display coupled to the non-transitory memory, the video display configured to display the transformed signal.

In one example, the transformed data packets have a reduced dimensionality compared to the second plurality of data packets. In one example, reduced dimensionality is a lower informational entropy or a reduction of degrees of freedom.

In one example, a non-transitory computer-readable medium storing computer executable code, operable on a device including at least one processor and at least one memory coupled to the at least one processor, wherein the at least one processor is configured to implement a lockless technique for data packet queue disposition, the computer executable code including: instructions for causing a computer to place a first plurality of data packets from a client of a plurality of clients into an assigned queue of a plurality of queues, wherein the assigned queue is associated with the client; instructions for causing the computer to transfer one or more contents of a notify queue list to a temporary notify list; instructions for causing the computer to retrieve a second plurality of data packets from the plurality of queues based on the temporary notify list; and instructions for causing the computer to process the second plurality of data packets according to a plurality of client applications to generate a plurality of transformed data packets.

In one example, the non-transitory computer-readable medium further includes instructions for causing the computer to enable a single of at least one constituent of the notify queue list. In one example, the non-transitory computer-readable medium further includes: instructions for causing the computer to assign the at least one constituent of the notify queue list to at least one queue of the plurality of queues; and instructions for causing a computer to clear one or more pending data packet queues from the notify queue list.

In one aspect, one or more of the steps for providing a lockless technique for data packet queue disposition in FIG. 4 may be executed by one or more processors which may include hardware, software, firmware, etc. The one or more processors, for example, may be used to execute software or firmware needed to perform the steps in the flow diagram of FIG. 4. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
placing a first plurality of data packets from a client of a plurality of clients into an assigned queue of a plurality of queues, wherein the assigned queue is associated with the client;
transferring one or more contents of a notify queue list to a temporary notify list;
retrieving a second plurality of data packets from the plurality of queues based on the temporary notify list; and
processing the second plurality of data packets according to a plurality of client applications to generate a plurality of transformed data packets.

2. The method of claim 1, wherein the transferring uses an atomic read operation on the notify queue list.

3. The method of claim 2, wherein the one or more contents of the notify queue list are data stored in the temporary notify list.

4. The method of claim 3, wherein the one or more contents include an aggregation of all constituents of the notify queue list.

5. The method of claim 4, wherein one of the all constituents is a single bit of the notify queue list.

6. The method of claim 1, wherein the retrieving uses a count leading zeros instruction to iterate through a list of queues having one or more pending data packets.

7. The method of claim 1, wherein the processing is performed to generate one or more application results which are returned to the plurality of clients.

8. The method of claim 1, further comprising enabling a single of at least one constituent of the notify queue list.

9. The method of claim 8, wherein the enabling is performed by setting a single bit to a logical value of one.

10. The method of claim 8, further comprising assigning the at least one constituent of the notify queue list to at least one queue of the plurality of queues.

11. The method of claim 10, further comprising clearing one or more pending data packet queues from the notify queue list.

12. The method of claim 11, wherein the clearing is executed by computing an atomic XOR logical operation using the notify queue list and the temporary notify list.

13. An apparatus comprising:
a non-transitory memory configured to store a first plurality of data packets and a second plurality of data packets;
a processing engine coupled to the non-transitory memory, the processing engine configured to transfer one or more contents of a notify queue list to a temporary notify list and further configured to process the second plurality of data packets according to a plurality of client applications to generate a plurality of transformed data packets; and
a databus coupled to the non-transitory memory and the processing engine, the databus configured to interconnect the processing engine and the non-transitory memory to transport the first plurality of data packets, the second plurality of data packets and the plurality of transformed data packets.

14. The apparatus of claim 13, further comprising a display processing unit (DPU) coupled to the non-transitory memory, the DPU configured to display the plurality of transformed data packets.

15. The apparatus of claim 14, further comprising a modem coupled to the non-transitory memory, the modem configured to convey the plurality of transformed data packets to an external entity.

16. The apparatus of claim 13, further comprising a digital signal processor (DSP) coupled to the non-transitory memory, the DSP configured to transform a signal embedded within the second plurality of data packets to generate a transformed signal not equal to the signal.

17. The apparatus of claim 16, further comprising a video display coupled to the non-transitory memory, the video display configured to display the transformed signal.

18. A non-transitory computer-readable medium storing computer executable code, operable on a device comprising at least one processor and at least one memory coupled to the at least one processor, wherein the at least one processor is configured to implement a lockless technique for data packet queue disposition, the computer executable code comprising:
instructions for causing a computer to place a first plurality of data packets from a client of a plurality of clients into an assigned queue of a plurality of queues, wherein the assigned queue is associated with the client;
instructions for causing the computer to transfer one or more contents of a notify queue list to a temporary notify list;
instructions for causing the computer to retrieve a second plurality of data packets from the plurality of queues based on the temporary notify list; and
instructions for causing the computer to process the second plurality of data packets according to a plurality of client applications to generate a plurality of transformed data packets.

19. The non-transitory computer-readable medium of claim 18, further comprising instructions for causing the computer to enable a single of at least one constituent of the notify queue list.

20. The non-transitory computer-readable medium of claim 19, further comprising:
instructions for causing the computer to assign the at least one constituent of the notify queue list to at least one queue of the plurality of queues; and
instructions for causing a computer to clear one or more pending data packet queues from the notify queue list.
